(19) United States
(12) Patent Application Publication
(10) Pub. No.: US 2021/0171669 A1
(43) Pub. Date: Jun. 10, 2021

(54) DIENE POLYMER MODIFIED BY AN EPOXIDE GROUP

(71) Applicant: COMPAGNIE GENERALE DES ETABLISSEMENTS MICHELIN, Clermont-Ferrand (FR)

(72) Inventors: Anne-Frédérique SALIT, Clermont-Ferrand Cedex 9 (FR); Benoît SCHNELL, Clermont-Ferrand Cedex 9 (FR); Sophie GANDER, Clermont-Ferrand Cedex 9 (FR); Sergey IVANOV, Clermont-Ferrand Cedex 9 (FR); Etienne FLEURY, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/762,713

(22) PCT Filed: Nov. 20, 2018
(86) PCT No.: PCT/FR2018/052911

§ 371 Date: May 8, 2020

(30) Foreign Application Priority Data
Nov. 21, 2017 (FR) 17/60958

(51) Int. Cl. C08C 19/06; C08K 3/36; B60C 1/00

(52) U.S. Cl. CPC C08C 19/06; B60C 1/0016; C08K 3/36

(57) ABSTRACT

A diene polymer including at least one specific epoxide side group, one of the carbon atoms of which simultaneously has an attachment to the polymer chain and is a trisubstituted carbon, and the other carbon atom is an at least trisubstituted carbon is provided. The introduction of such a polymer, in particular elastomer, into a rubber composition makes it possible to improve its rupture properties without this being at the expense of its hysteresis properties, while at the same time improving its implementation.

This application is a 371 national phase entry of PCT/FR2018/052911 filed on 20 Nov. 2018, which claims benefit of French Patent Application No. 1760958, filed 21 Nov. 2017, the entire contents of which are incorporated herein by reference for all purposes.

### BACKGROUND

### 1. Technical Field

The field of the present invention is that of diene polymers which are modified in that they bear at least one functional side group, more particularly diene polymers modified with epoxide side groups.

### 2. Related Art

Patent application US 2012/0046418 A1 discloses diene polymers bearing glycidyl side groups. These functional polymers, notably elastomers, may be used crosslinked in a rubber composition, the presence of the glycidyl side groups making it possible to crosslink the diene polymer in the presence of a crosslinking agent other than sulfur. It turns out that the polymers thus modified give the rubber composition which contains them degraded rupture properties.

Now, a crosslinked rubber composition must have good rupture properties in order to be able to be used in a semi-finished article for tires. Specifically, during rolling, a tire is subjected to high stresses and to great strains, given that it must also have the lowest possible rolling resistance.

### SUMMARY

The Applicant has discovered, surprisingly, that the introduction of diene polymers, in particular elastomers, bearing at least one specifically substituted epoxide side group in a rubber composition makes it possible to improve its rupture properties without this being at the expense of its hysteresis properties, while at the same time improving its implementation.

A first subject of the invention is a polymer including at least one epoxide side group of formula (I)

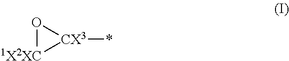

in which:
* represents an attachment to the main polymer chain,
X¹ and X², which may be identical or different, represent a hydrogen atom or a monovalent substituent,
X³ represents a hydrogen atom, and
at least one from among X¹ and X² is other than a hydrogen atom.

The invention also relates to a rubber composition which comprises a reinforcing filler, a crosslinking system and a diene elastomer in accordance with the invention.

Another subject of the invention is a tire which comprises a rubber composition in accordance with the invention.

### I. DETAILED DESCRIPTION OF EXAMPLE EMBODIMENTS

In the present description, unless expressly indicated otherwise, all the percentages (%) shown are mass percentages. The abbreviation “phr” means parts by weight per hundred parts of elastomer (of the total of the elastomers, if several elastomers are present).

Furthermore, any interval of values denoted by the expression “between a and b” represents the range of values greater than “a” and less than “b” (i.e. limits a and b excluded), whereas any interval of values denoted by the expression “from a to b” means the range of values extending from “a” up to “b” (i.e. including the strict limits a and b).

The compounds mentioned in the description may be of fossil or biobased origin. In the latter case, they may be partially or totally derived from biomass or may be obtained from renewable starting materials derived from biomass. Polymers, plasticizers, fillers, etc., are also concerned.

The diene polymer in accordance with the invention has the essential characteristic of containing both diene units and at least one particular epoxide side group. It is considered as a functionalized diene polymer.

The term “diene unit” means a unit which results from the insertion of a diene monomer (monomers bearing two conjugated or non-conjugated carbon-carbon double bonds) by polymerization in a polymer chain and which contains a carbon-carbon double bond.

Given these definitions, the term “diene polymer” more particularly means in the present invention:

(a)—any homopolymer of a conjugated diene monomer, notably any homopolymer obtained by polymerization of a conjugated diene monomer containing from 4 to 12 carbon atoms;

(b)—any copolymer obtained by copolymerization of one or more dienes conjugated with each other or with one or more vinylaromatic compounds containing from 8 to 20 carbon atoms;

(c)—a ternary copolymer obtained by copolymerization of ethylene and of an α-olefin containing from 3 to 6 carbon atoms with a non-conjugated diene monomer containing from 6 to 12 carbon atoms, for instance the elastomers obtained from ethylene and propylene with a non-conjugated diene monomer of the abovementioned type, notably such as 1,4-hexadiene, ethylidenenorbornene or dicyclopentadiene;

(d)—a copolymer of isobutene and of isoprene (butyl rubber), and also the halogenated versions, in particular chlorinated or brominated versions, of this type of copolymer;

(e) any copolymer obtained by copolymerization of one or more conjugated dienes with ethylene, an acyclic aliphatic α-monoolefin containing from 3 to 18 carbon atoms or a mixture thereof, for instance those described in WO 2005/028526, WO 2004/035639 and WO 2007/054224.

The diene monomer is preferably a 1,3-diene, notably 1,3-butadiene or isoprene, in which case the diene unit of the diene polymer is 1,3-butadiene or 1,3-isoprene monomer units, preferably 1,3-butadiene.

Preferentially, the diene polymer which bears the side groups is chosen from the group consisting of polybutadienes, polyisoprenes, butadiene copolymers, isoprene copolymers and mixtures thereof. More preferentially, the diene polymer is a synthetic elastomer. In other words, the diene polymer is not a natural rubber. It is recalled that the natural rubber conventionally used as elastomer in rubber compositions originates from the rubbery dry material of natural rubber latex, which is very often extracted from rubber trees and is thus not considered a synthetic elastomer. Very preferentially, the diene polymer is an elastomer.

The epoxide side group borne by the diene polymer in accordance with the invention corresponds to formula (I)

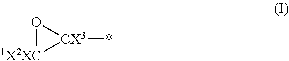

in which:
* represents an attachment to the main polymer chain,
X¹ and X², which may be identical or different, represent a hydrogen atom or a monovalent substituent,
X³ represents a hydrogen atom, and
at least one from among X¹ and X² is other than a hydrogen atom.

Preferably, the epoxide side group is outside of the ends of the main polymer chain.

Preferably, the diene polymer includes several epoxide side groups that are useful for the purposes of the invention. The presence of several epoxide side groups, notably outside of the ends of the main polymer chain, makes it possible to give better elastic properties to the polymer in crosslinked form. The content of epoxide side groups that is useful for the purposes in the polymer may vary within a wide range, depending on the intended application of the polymer. According to any one of the embodiments of the invention, the epoxide side group is preferentially present in a content ranging from 0.01 to 5 mol %, more preferentially from 0.01 to 1 mol %, even more preferentially from 0.1 to 1 mol %. This content expressed as a molar percentage is equivalent to the number of epoxide side groups that are useful in the invention per 100 units of the polymer (moles of monomer units constituting the polymer, including those which bear the side groups).

According to a preferential embodiment, X¹ represents a substituent group and X² represents a hydrogen atom.

According to another preferential embodiment of the invention, X¹ and X² each represent a substituent group.

Preferably, the substituent group represented by the symbols X¹ or X² is a carbon-based group, in particular a hydrocarbon-based group. The substituent group may be aliphatic or aromatic, and linear, branched or cyclic. Substituent groups that are particularly suitable are alkyls and aryls, more particularly alkyls containing 1 to 6 carbon atoms, preferably methyl, or aryls containing 6 to 12 carbon atoms, preferably phenyl.

According to a particular embodiment of the invention, the epoxide side group is attached to the main chain of the polymer by being grafted onto a diene unit of the diene polymer. In other words, the point of attachment of each epoxide side group to the diene polymer takes place via a grafting reaction on a diene unit.

According to this particular embodiment of the invention, the epoxide group is grafted onto the diene polymer by reaction of a 1,3-dipolar compound and of a starting diene polymer.

Preferably, the 1,3-dipolar compound is chosen from the group consisting of nitrile oxides, nitrile imines and nitrones. The 1,3-dipolar compound is then such that the symbol Q contains a —C≡N→O, —C≡N— or —C═N(→O)— unit. Advantageously, the 1,3-dipolar compound is a nitrile oxide.

The 1,3-dipolar compound generally comprises a benzene nucleus substituted with the dipole of the 1,3-dipolar compound and preferably also substituted ortho to the dipole. Very advantageously, the 1,3-dipolar compound is an aromatic nitrile oxide, i.e. an aromatic compound substituted with a nitrile oxide dipole. Better still, the 1,3-dipolar compound is an aromatic nitrile monoxide, which corresponds to a compound which contains only one nitrile oxide dipole and which is an aromatic compound substituted with the nitrile oxide dipole (—C≡N→O).

More preferentially, the 1,3-dipolar compound contains a unit of formula (II) in which four of the five symbols R1 to R5, which may be identical or different, are each an atom or a group of atoms, and the fifth symbol represents a carbon-based chain allowing attachment to the epoxide group, given that at least one from among R1 and R5 is other than a hydrogen atom.

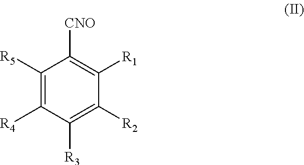

The term “group of atoms” means a sequence of atoms covalently bonded to form a chain. Two groups Ri and Ri+1, for i which is an integer ranging from 1 to 4, may form, together with the carbon atoms of the benzene nucleus to which they are attached, a ring.

Preferably, R1, R3 and R5 each represent a hydrocarbon-based group and R2 or R4 represents the fifth symbol. More preferentially, R1, R3 and R5 each represent an alkyl, even more preferentially a methyl or an ethyl.

The carbon-based chain represented by the fifth symbol may be aliphatic or aromatic, and linear, branched or cyclic, preferably saturated. The fifth symbol preferentially represents a carbon-based chain interrupted with one or more heteroatoms, preferably oxygen. The term “carbon-based chain” means a chain which comprises one or more carbon atoms. The carbon-based chain may be a hydrocarbon-based chain. The carbon-based chain may comprise one or more ether functions; in particular, the fifth symbol comprises a —CH₂O— unit, the methylene group being attached to the epoxide group.

Very advantageously, the 1,3-dipolar compound is a compound of formula (III), (IV) or (V).

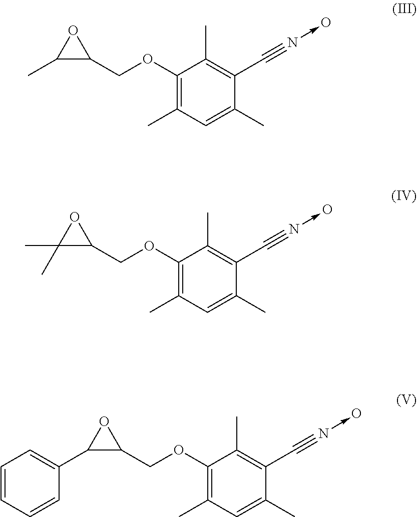 [SMILES: Cc1cc(C)c(OCC2OC2C)c(C)c1C#[N+][O-] ; Cc1cc(C)c(OCC2OC2(C)C)c(C)c1C#[N+][O-] ; Cc1cc(C)c(OCC2OC2c2ccccc2)c(C)c1C#[N+][O-]]

The grafting proceeds from a [2+3] cycloaddition reaction of the dipole on a carbon-carbon double bond according to a well-known mechanism. The grafting of the 1,3-dipolar compound may be performed in bulk, for example in an internal mixer or an external mixer, such as an open mill. The grafting is then performed either at a temperature of the external mixer or of the internal mixer of less than 60° C., followed by a step of a grafting reaction under a press or in an oven at temperatures ranging from 80° C. to 200° C., or at a temperature of the external mixer or of the internal mixer of greater than 60° C., without subsequent heat treatment. When the grafting is performed in bulk it is preferentially performed in the presence of an antioxidant. The grafting of the 1,3-dipolar compound on the polymer may be performed prior to the introduction of the polymer into a rubber composition, or during the manufacture of the composition.

The grafting process may also be performed in solution, continuously or batchwise. The diene polymer thus modified may be separated from its solution by any type of means known to those skilled in the art and in particular by a steam stripping operation.

The starting diene polymer is any diene polymer, in particular elastomer, i.e. any polymer consisting at least partly (i.e. a homopolymer or a copolymer) of diene monomer units. For the purpose of synthesizing the polymer in accordance with the invention which contains both diene units and epoxide side groups, a person skilled in the art understands that the mole fraction of diene units in the starting diene polymer is greater than the targeted value of the mole fraction of epoxide side group that it is desired to graft onto the diene polymer.

The starting diene polymer, preferentially elastomer, may be:

(a)—any homopolymer of a conjugated diene monomer, notably any homopolymer obtained by polymerization of a conjugated diene monomer containing from 4 to 12 carbon atoms;

(b)—any copolymer obtained by copolymerization of one or more conjugated dienes with each other or with one or more vinylaromatic compounds containing from 8 to 20 carbon atoms;

(c)—any ternary copolymer obtained by copolymerization of ethylene, of an α-olefin containing from 3 to 6 carbon atoms with a non-conjugated diene monomer containing from 6 to 12 carbon atoms, for instance the elastomers obtained from ethylene and propylene with a non-conjugated diene monomer of the abovementioned type, notably such as 1,4-hexadiene, ethylidenenorbornene or dicyclopentadiene;

(d)—any copolymer of isobutene and of isoprene (butyl rubber) and also the halogenated versions, in particular chlorinated or brominated versions, of this type of copolymer;

(e)—any copolymer obtained by copolymerization of one or more conjugated dienes with ethylene, an α-monoolefin containing from 3 to 18 carbon atoms or a mixture thereof, for instance those described in WO 2005/028526, WO 2004/035639 and WO 2007/054224.

The diene monomer is preferably a 1,3-diene, notably 1,3-butadiene or isoprene, in which case the diene unit of the diene polymer is 1,3-butadiene or 1,3-isoprene monomer units, preferably 1,3-butadiene.

Preferentially, the starting diene polymer is chosen from the group consisting of polybutadienes, polyisoprenes, butadiene copolymers, isoprene copolymers and mixtures thereof. More preferentially, the starting diene polymer is a synthetic polymer. In other words, the starting polymer is not a natural rubber. The starting diene polymer may be a 1,3-butadiene homopolymer, an isoprene homopolymer, a 1,3-butadiene copolymer, an isoprene copolymer or mixtures thereof. The starting diene polymer is more preferentially a diene elastomer, notably a 1,3-butadiene homopolymer, an isoprene homopolymer, a 1,3-butadiene copolymer, an isoprene copolymer or mixtures thereof.

The copolymer in accordance with the invention, notably when it is an elastomer, may be used in a rubber composition, which is another subject of the invention.

The rubber composition also comprises a crosslinking system, notably to improve the elasticity properties of the rubber composition.

According to a first variant of the invention, the crosslinking system comprises a compound that is reactive towards the diene units of the diene polymer. According to this variant, the crosslinking system is based on sulfur, peroxides or peroxide or bismaleimides. When the crosslinking system is a vulcanization system, it may comprise vulcanization accelerators, vulcanization retardants or vulcanization activators.

According to a second variant of the invention, the crosslinking system comprises a compound that is reactive towards the substituted epoxide group. According to this variant, the compound that is reactive towards the substituted epoxide group contains at least two nucleophilic functions chosen from an acid function, a hydrazide function and an amine function. According to this variant, polyacids, notably diacids as described in the patent applications WO 2014/095582 and WO 2014/095585, are most particularly suitable for use.

Preferably, the crosslinking system is based on sulfur, i.e. a vulcanization system.

The rubber composition also comprises a reinforcing filler, notably to give the rubber composition the reinforcing properties required for the application in which the rubber composition is intended to be used.

The composition of the invention includes any type of “reinforcing” filler known for its abilities to reinforce a rubber composition which can be used in the manufacture of tires, for example an organic filler, such as carbon black, a reinforcing inorganic filler, such as silica, with which a coupling agent is combined in a known manner, or else a mixture of these two types of filler. Such a reinforcing filler typically consists of nanoparticles, the (mass-) average size of which is less than a micrometre, generally less than 500 nm, most usually between 20 and 200 nm, in particular and more preferentially between 20 and 150 nm.

According to a particular embodiment of the invention, the reinforcing filler comprises a reinforcing inorganic filler, preferentially a silica. According to this embodiment of the invention, the reinforcing inorganic filler represents more than 50% by mass relative to the mass of the reinforcing filler of the rubber composition. The reinforcing inorganic filler is then said to be predominant.

When it is combined with a predominant reinforcing inorganic filler, such as silica, the carbon black is preferably used at a content of less than 20 phr, more preferentially of less than 10 phr (for example, between 0.5 and 20 phr, notably between 2 and 10 phr). Within the intervals indicated, the colouring properties (black pigmenting agent) and UV-stabilizing properties of the carbon blacks are beneficial, without, moreover, adversely affecting the typical performance qualities contributed by the reinforcing inorganic filler.

Preferentially, the content of total reinforcing filler is between 30 and 160 phr, more preferentially between 40 phr and 160 phr. Below 30 phr, the reinforcement of the rubber composition is insufficient to contribute an appropriate level of cohesion or wear resistance of the rubber component of the tire comprising this composition. Even more preferentially, the content of total reinforcing filler is at least 50 phr. Above 160 phr, there is a risk of increase in the hysteresis and thus in the rolling resistance of the tires. For this reason, the content of total reinforcing filler is preferably within a range extending from 50 to 120 phr, notably for use in a tire tread. Any one of these ranges of content of total reinforcing filler may apply to any one of the embodiments of the invention.

In order to couple the reinforcing inorganic filler to the diene elastomer, use is made, in a well-known manner, of an at least difunctional coupling agent, notably a silane, (or bonding agent) intended to provide a satisfactory connection, of chemical and/or physical nature, between the inorganic filler (surface of its particles) and the diene elastomer. Use is made in particular of organosilanes or polyorganosiloxanes which are at least difunctional. More particularly, use is made of silane polysulfides, referred to as “symmetrical” or “asymmetrical” depending on their specific structure, as described, for example, in patent applications WO 03/002648 (or US 2005/016651) and WO 03/002649 (or US 2005/016650). As examples of polysulfide silanes, mention will be made more particularly of bis((C₁-C₄)alkoxyl(C₁-C₄)alkylsilyl(C₁-C₄)alkyl) polysulfides (notably disulfides, trisulfides or tetrasulfides), for instance bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂.

The content of coupling agent is advantageously less than 20 phr, it being understood that it is generally desirable to use as little as possible thereof. Typically, the content of coupling agent represents from 0.5% to 15% by weight relative to the amount of inorganic filler. Its content is preferentially between 0.5 and 12 phr, more preferentially within a range extending from 3 to 10 phr. This content is readily adjusted by a person skilled in the art depending on the content of inorganic filler used in the composition.

The rubber composition in accordance with the invention may also contain, in addition to the coupling agents, coupling activators, agents for covering the inorganic fillers or more generally processing aids that are capable, in a known manner, by means of improving the dispersion of the filler in the rubber matrix and of lowering the viscosity of the compositions, of improving their ability to be processed in the uncured state.

The rubber composition in accordance with the invention may also include all or some of the usual additives customarily used in elastomer compositions intended to constitute external mixtures for finished rubber articles, such as tires, in particular for treads, for instance plasticizers or extending oils, pigments, protective agents, such as antiozone waxes, chemical antiozonants, antioxidants, antifatigue agents, reinforcing resins (such as resorcinol or bismaleimide), methylene acceptors (for example phenolic novolac resin) or methylene donors (for example HMT or H3M), as described, for example, in patent application WO 02/10269.

The rubber composition in accordance with the invention is manufactured in appropriate mixers, using two successive phases of preparation well known to those skilled in the art: a first phase of thermomechanical working or kneading (“non-productive” phase) at high temperature, up to a maximum temperature of between 130° C. and 200° C., followed by a second phase of mechanical working (“productive” phase) down to a lower temperature, typically below 110° C., for example between 40° C. and 100° C., during which finishing phase the crosslinking system is incorporated.

Thus, the rubber composition in accordance with the invention may be manufactured via any process which comprises the following steps:
adding the reinforcing filler and, where appropriate, the other ingredients of the rubber composition with the exception of the crosslinking system to the diene elastomer bearing the epoxide side group, during a first “non-productive” step, kneading thermomechanically until a maximum temperature of between 130° C. and 200° C. is reached,
cooling the combined mixture to a temperature below 100° C.,
subsequently incorporating the crosslinking system,
kneading the whole up to a maximum temperature below 120° C.

According to a particular embodiment of the invention, the rubber composition in accordance with the invention is manufactured via a process which comprises the following steps:
kneading a diene elastomer corresponding to the definition of the starting diene elastomer described previously and a 1,3-dipolar compound as described previously, during a first “non-productive” step, by thermomechanically kneading,
then adding the reinforcing filler and, where appropriate, the other ingredients of the rubber composition with the exception of the crosslinking system, kneading thermomechanically until a maximum temperature of between 130° C. and 200° C. is reached,
cooling the combined mixture to a temperature below 100° C.,
subsequently incorporating the crosslinking system,
kneading the whole up to a maximum temperature below 120° C.

The contact time between the diene elastomer and the 1,3-dipolar compound which are thermomechanically kneaded is adjusted as a function of the conditions of the thermomechanical kneading, notably as a function of the temperature. The higher the temperature of the kneading, the shorter this contact time. Typically, it is from 1 to 5 minutes for a temperature of 100° C. to 130° C.

After the incorporation of all the ingredients of the rubber composition, the final composition thus obtained is subsequently calendered, for example in the form of a sheet or slab, notably for laboratory characterization, or else extruded, in order to form, for example, a rubber profiled element used as rubber component in the preparation of the tire, notably a tire tread.

The rubber composition in accordance with the invention may either be in the uncured state (before crosslinking or vulcanization) or in the cured state (after crosslinking or vulcanization). It is preferentially used in a tire, for example as a semi-finished article.

The abovementioned characteristics of the present invention, and also others, will be understood more clearly on reading the following description of several implementational examples of the invention, given as non-limiting illustrations.

### II. IMPLEMENTATIONAL EXAMPLES

### II.1-Measurements and Tests Used:

### NMR Analysis:

The structural analysis and the determination of the molar purities of the molecules synthesized are performed by NMR analysis. The spectra are acquired on a 400 MHz Bruker Avance 3 spectrometer equipped with a 5 mm BBFO Z-grad “broad band” probe. The quantitative ¹H NMR experiment uses a simple 30° pulse sequence and a repetition time of 3 seconds between each of the 64 acquisitions. The samples are dissolved in deuterated dimethyl sulfoxide (DMSO). This solvent is also used for the lock signal. Calibration is performed on the signal of the protons of the deuterated DMSO at 2.44 ppm relative to a TMS reference at 0 ppm. The ¹H NMR spectrum coupled with the 2D ¹H/¹³C HSQC and ¹H/¹³C HMBC experiments enable the structural determination of the molecules (cf. tables of assignments). The molar quantifications are performed from the quantitative 1D ¹H NMR spectrum.

The determination of the molar content of grafted nitrile oxide compound is performed by NMR analysis. The spectra are acquired on a 500 MHz Bruker spectrometer equipped with a “5 mm BBFO Z-grad CryoProbe”. The quantitative ¹H NMR experiment uses a simple 30° pulse sequence and a repetition time of 5 seconds between each acquisition. The samples are dissolved in deuterated chloroform (CDCl₃) with the aim of obtaining a “lock” signal.

2D NMR experiments made it possible to confirm the nature of the grafted unit by means of the chemical shifts of the carbon atoms and protons.

### Tensile Tests:

The elongations at break and the breaking stresses are measured by means of tensile tests according to the French standard NF T 46-002 of September 1988. All these tensile measurements are performed under the standard conditions of temperature (23±2° C.) and hygrometry (50±5% relative humidity), according to the French standard NF T 40-101 (December 1979).

### Dynamic Properties:

The dynamic properties tan(δ)max are measured on a viscosity analyser (Metravib VA4000) according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) according to standard ASTM D 1349-99, is recorded. A strain amplitude sweep is performed from 0.1% to 100% (outward cycle), and then from 100% to 0.1% (return cycle). The results exploited are the complex dynamic shear modulus (G*) at 25% strain, the loss factor tan(δ) and the difference in modulus (ΔG*) between the values at 0.1% and 100% strain (Payne effect). For the return cycle, the maximum value of tan(δ) observed, denoted tan(δ)max, is indicated.

### Rheometry:

The measurements are performed at 150° C. with an oscillating disc rheometer, according to the standard DIN 53529—Part 3 (June 1983). The measurements are processed according to the standard DIN 53529—Part 2 (March 1983). The change in the rheometric torque as a function of time describes the change in the stiffening of the composition as a result of the vulcanization reaction and thus makes it possible to monitor the vulcanization progress. The minimum torque value Cmin is measured for each composition. The Cmin is representative of the viscosity in the uncured state (before vulcanization) of the rubber composition and makes it possible to evaluate the processability of the rubber composition.

### II.2-Preparation of the Modified Polymers:

The starting polymers are the following elastomers:
E1: a copolymer of 1,3-butadiene and of styrene (SBR) containing 26% of styrene units and 56% of 1,2-butadiene units
E2: a copolymer of 1,3-butadiene and of styrene (SBR) containing 26% of styrene units and 24% of 1,2-butadiene units
E3: a synthetic polyisoprene with a high cis content, Nipol2200 from Nippon Zeon
E4: natural rubber.

The elastomers are modified by grafting the 1,3-dipolar compound according to the following procedure:

The 1,3-dipolar compound is incorporated into the elastomer using an internal mixer (roll machine) at 30° C., the amount of compound added is 0.5 mol per 100 mol of diene monomer units of the elastomer. The mixture is homogenized in 15 turnover passes. This mixing phase is followed by a heat treatment at 120° C. for 10 to 60 minutes under a press at a pressure of 10 bar.

The 1,3-dipolar compounds used are compounds D-1 to D-4 and were prepared in accordance with section 11.3.

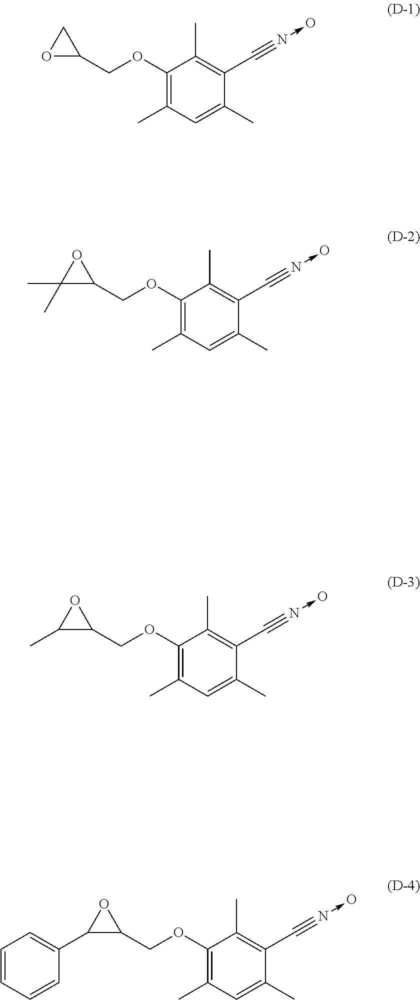 [SMILES: Cc1cc(C)c(OCC2CO2)c(C)c1C#[N+][O-] ; Cc1cc(C)c(OCC2OC2(C)C)c(C)c1C#[N+][O-] ; Cc1cc(C)c(OCC2OC2C)c(C)c1C#[N+][O-] ; Cc1cc(C)c(OCC2OC2c2ccccc2)c(C)c1C#[N+][O-]]

The content of epoxide side group in the polymer is determined by NMR analysis for each of the modified elastomers and is given in the following table:

| Content | | | |
|---|---|---|---|
| of epoxide | | | |
| side group | D-1 | D-2 | D-3 |
| E1 | 0.37% | 0.50% | 0.50% |
| E2 | 0.50% | 0.50% | 0.45% |
| E3 | 0.19% | 0.50% | 0.25% |
| E4 | 0.15% | 0.24% | 0.20% |

### II.3-Synthesis of the 1,3-Dipolar Compounds:

The following 1,3-dipolar compounds D-1, D-2, D-3 and D-4, respectively, were prepared.

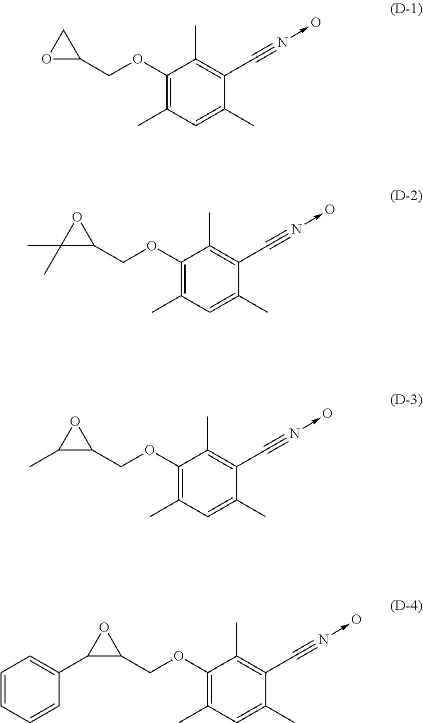 [SMILES: Cc1cc(C)c(OCC2CO2)c(C)c1C#[N+][O-] ; Cc1cc(C)c(OCC2OC2(C)C)c(C)c1C#[N+][O-] ; Cc1cc(C)c(OCC2OC2C)c(C)c1C#[N+][O-] ; Cc1cc(C)c(OCC2OC2c2ccccc2)c(C)c1C#[N+][O-]]

### Synthesis of 3-hydroxy-2,4,6-trimethylbenzaldehyde (Target 1)

Target compound 1 (or A) is a common precursor used in the synthesis of some of the 1,3-dipolar compounds. It is synthesized according to the following scheme:

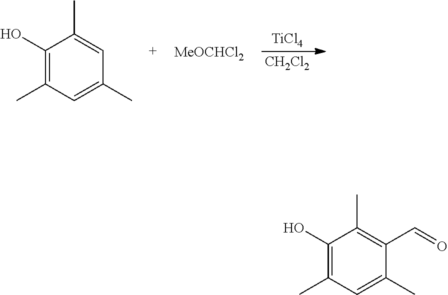

Target compound 1 may be obtained according to a procedure described in the article Yakubov, A. P.; Tsyganov, D. V.; Belen'kii, L. I.; Krayushkin, M. M. Bulletin of the Academy of Sciences of the USSR, Division of Chemical Science (English Translation); vol. 40; nb. 7.2; (1991); pages 1427-1432; Izvestiya Akademii Nauk SSSR, Seriya Khimicheskaya; nb. 7; (1991); pages 1609-1615.

### Synthesis of 2,4,6-trimethyl-3-(oxiran-2-ylmethoxy)benzonitrile Oxide (D-1)

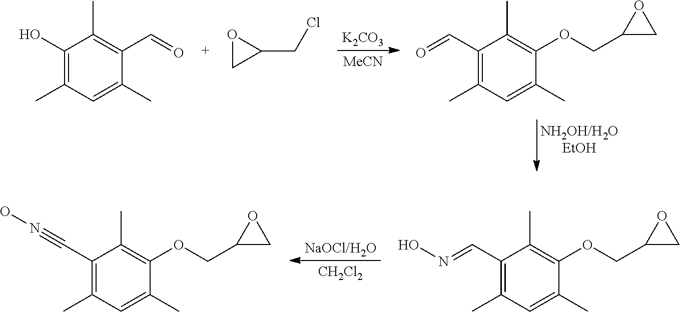

### Synthesis of 2,4,6-trimethyl-3-(oxiran-2-ylmethoxy)benzaldehyde (Target 2)

Potassium carbonate (50.50 g, 0.365 mol) is added to a mixture of 3-hydroxy-2,4,6-trimethylbenzaldehyde (40.00 g, 0.244 mol) and epichlorohydrin (56.35 g, 0.609 mol) in acetonitrile (100 ml). The reaction medium is stirred at 60° C. for 3 hours and then at 70° C. for 2.5-3 hours. After returning to 40-50° C., the reaction mixture is diluted with a mixture of water (250 ml) and ethyl acetate (250 ml) and then kept stirring for 10 minutes. The organic phase is separated out and washed with water (4 times with 125 ml). The solvent is evaporated off under reduced pressure (T_{bath} 37° C., 40 mbar). A red oil (66.43 g) is obtained.

The second reaction product, 3,3′-((2-hydroxypropane-1,3-diyl)bis(oxy))bis(2,4,6-trimethylbenzaldehyde), is separated from the target product 2 by chromatography on a column of silica (eluent: 1/4 ethyl acetate/petroleum ether). After recovering the fractions of the target product 2, the solvents are evaporated off under reduced pressure (T_{bath} 36° C., 21 mbar). Petroleum ether (120 ml) is added to the residue and the suspension is kept stirring at −18° C. for 2 hours. The precipitate is filtered off, washed on the filter with petroleum ether (40/60) (three times 25 ml) and finally dried under atmospheric pressure at room temperature for 10-15 hours. A white solid (40.04 g, yield by mass of 75%) with a melting point of 52° C. is obtained. The molar purity is greater than 99% (¹H NMR).

Assignment table:

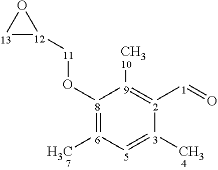

| | δ¹H (ppm) | δ¹³C (ppm) |
|---|---|---|
| 1 | 10.37 | 193.3 |
| 2 | / | 131.1 |
| 3 | / | 132.8 |
| 4 | 2.4 | 19.2 |
| 5 | 6.94 | 131.3 |
| 6 | / | 136.3 |
| 7 | 2.2 | 16.1 |
| 8 | / | 153.4 |
| 9 | / | 135.7 |
| 10 | 2.4 | 11.7 |
| 11 | 3.50/4.00 | 73.4 |
| 12 | 3.29 | 49.6 |
| 13 | 2.60/2.76 | 42.9 |

### Solvent DMSO

### Synthesis of 2,4,6-trimethyl-3-(oxiran-2-ylmethoxy)benzaldehyde oxime (Target 3)

A solution of hydroxylamine (16.81 g, 0.254 mol, 50% in water, Aldrich) in ethanol (75 ml) is added at room temperature to a solution of 2,4,6-trimethyl-3-(oxiran-2-ylmethoxy)benzaldehyde (46.70 g, 0.212 mol) in ethanol (750 ml). The reaction medium is stirred at 23° C. (T_{bath}) for 3 hours. After evaporating off the solvent (T_{bath} 24° C., 35 mbar), petroleum ether (40/60) (150 ml) is added. The precipitate is filtered off and washed on the filter with petroleum ether (100 ml). The crude product is dissolved in a mixture of ethyl acetate (650 ml) and petroleum ether (650 ml) at room temperature and this solution is filtered on a bed of silica gel (Ø9 cm, 2.0 cm of SiO₂).

The solvents are evaporated off (T_{bath} 22-24° C.) and the target product 3 is dried at atmospheric pressure at room temperature. A white solid (43.81 g, yield by mass of 88%) with a melting point of 77° C. is obtained. The molar purity is greater than 99% (¹H NMR).

Assignment table:

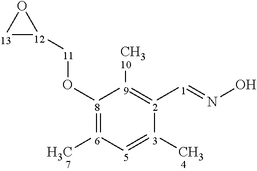

| | δ¹H (ppm) | δ¹³C (ppm) |
|---|---|---|
| 1 | 8.2 | 147.3 |
| 2 | / | 129.1 |
| 3 | / | 129.2 |
| 4 | 2.18 | 20.1 |
| 5 | 6.85 | 130.2 |
| 6 | / | 130.3 |
| 7 | 2.15 | 15.7 |
| 8 | / | 153.1 |
| 9 | / | 131.7 |
| 10 | 2.18 | 13.1 |
| 11 | 3.48/3.96 | 73.3 |
| 12 | 3.27 | 49.6 |
| 13 | 2.60/2.76 | 42.8 |

### Solvent DMSO

### Synthesis of 2,4,6-trimethyl-3-(oxiran-2-ylmethoxy)benzonitrile Oxide (D-1)

An aqueous solution of NaOCl in water (62.9 g active Cl/I) (126 ml) is added dropwise over 10-15 minutes to a solution of 2,4,6-trimethyl-3-(oxiran-2-ylmethoxy)benzaldehyde oxime (17.00 g, 0.072 mol) in dichloromethane (350 ml) cooled to 3° C. The temperature of the reaction medium remains between 3 and 5° C. The reaction medium is then stirred for 1 hour at a temperature of 3-5° C. The aqueous phase is separated out and extracted with dichloromethane (25 ml). The combined organic phases are washed with water (three times 75 ml). The solvent is evaporated off under reduced pressure (T_{bath} 22° C., 35 mbar). Petroleum ether (40/60) (90 ml) is added to this residue and the suspension is kept stirring at room temperature for 10-12 hours. The precipitate is filtered off, washed on the filter with petroleum ether (three times 30 ml) and finally dried at atmospheric pressure at room temperature for 10-15 hours. A white solid (15.12 g, yield by weight of 90%) with a melting point of 63° C. is obtained. The molar purity is greater than 99% (¹H NMR).

Assignment table:

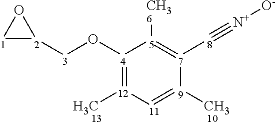

| | δ¹H (ppm) | δ¹³C (ppm) |
|---|---|---|
| 1 | 2.59/2.76 | 43.0 |
| 2 | 3.28 | 49.6 |
| 3 | 3.51/4.03 | 73.5 |
| 4 | / | 153.0 |
| 5 | / | 136.3 |
| 6 | 2.27 | 14.3 |
| 7 | / | 111.7 |
| 8 | / | / |
| 9 | / | 134.4 |
| 10 | 2.18 | 15.9 |
| 11 | 7.01 | 129.9 |
| 12 | / | 134.0 |
| 13 | 2.27 | 19.5 |

### Solvent DMSO

### Synthesis of 2,4,6-trimethyl-3-(3-(3,3-dimethyloxiran-2-yl)propoxy]benzonitrile Oxide (D-2)

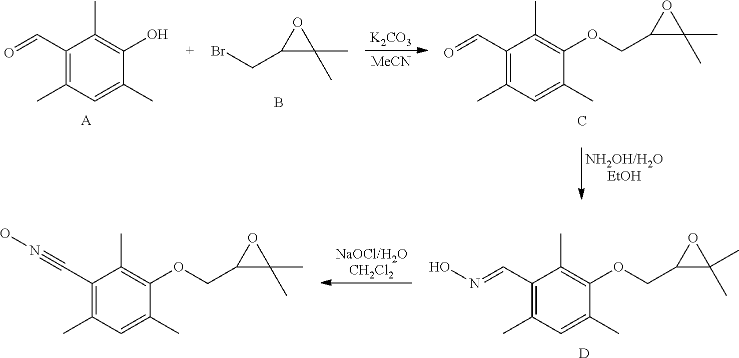

### Synthesis of 3-(bromomethyl)-2,2-dimethyloxirane (B)

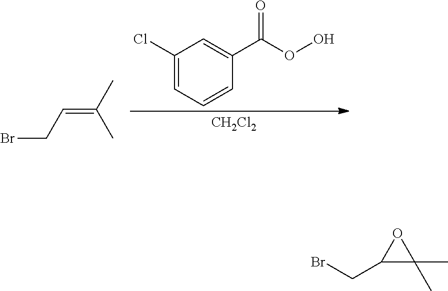

Compound B may be obtained according to a procedure described in the article Shimizu, Hitoshi et al.; Organic Process Research & Development, 9(3), 278-287; 2005

### Synthesis of 3-((3,3-dimethyloxiran-2-yl)methoxy)-2,4,6-trimethylbenzaldehyde (C)

Potassium carbonate (12.12 g, 0.877 mol) is added to a mixture of 3-hydroxy-2,4,6-trimethylbenzaldehyde (19.20 g, 0.117 mol) and 3-(bromomethyl)-2,2-dimethyloxirane (19.30 g, 0.117 mol) in acetonitrile (50 ml). The reaction medium is stirred at 60° C. (T_{bath}) for 10-11 hours. After returning to room temperature, the reaction mixture is diluted with a mixture of water (700 ml) and ethyl acetate (100 ml) and stirred for 10 minutes. The aqueous phase is separated out and extracted with ethyl acetate (three times 75 ml). The combined organic phases are washed twice with NaOH solution (8.0 g in 100 ml of water) and with water (five times 75 ml). The solvent is evaporated off under reduced pressure (T_{bath} 35° C., 10 mbar). A pale yellow oil (28.18 g, yield by mass of 97%) is obtained. The molar purity is greater than 85% CH NMR). Product C is used for the following step without any further purification.

Assignment table:

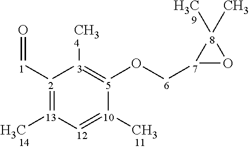

| | δ¹H (ppm) | δ¹³C (ppm) |
|---|---|---|
| 1 | 10.4 | 192.6 |
| 2 | / | 131.2 |
| 3 | / | 133.3 |
| 4 | 2.43 | 12 |
| 5 | / | 153.7 |
| 6 | 3.67 and 3.87 | 71.3 |
| 7 | 3.09 | 61.1 |
| 8 | / | 57.8 |
| 9 | 1.17 and 1.28 | 18.6 and 24.3 |
| 10 | / | 125.8 |
| 11 | 2.21 | 16.5 |
| 12 | 6.79 | 13.5 |
| 13 | / | 136.4 |
| 14 | 2.4 | 19.5 |

### Solvent CDCl₃

### Synthesis of 3-((3,3-dimethyloxiran-2-yl)methoxy)-2,4,6-trimethylbenzaldehyde Oxime (D)

A solution of hydroxylamine (5.02 g, 0.760 mol, 50% in water, Aldrich) in ethanol (10 ml) is added to a solution of 3-((3,3-dimethyloxiran-2-yl)methoxy)-2,4,6-trimethylbenzaldehyde (11.8 g, 0.475 mol) in ethanol (25 ml) at 40° C. (T_{bath}). The reaction medium is stirred at 55° C. (T_{bath}) for 2.5-3.0 hours. After evaporating off the solvent (T_{bath} 32° C., 26 mbar), a mixture of ethyl acetate (20 ml), petroleum ether (40/60) (30 ml) and water (10 ml) is added.

The organic phase is then separated out and washed with water (10 ml). The solution is filtered through a bed of silica gel (Ø3.5 cm, h=2.0 cm) and the bed of silica gel is then washed with a mixture of ethyl acetate (10 ml) and petroleum ether (20 ml). After evaporating off the solvents (T_{bath} 33° C., 11 mbar), a colourless oil (10.33 g, yield by mass of 83%) is obtained. The molar purity is greater than 78% (¹H NMR) and 16% of EtOAc. Product D is used in the following step without any further drying.

Assignment table:

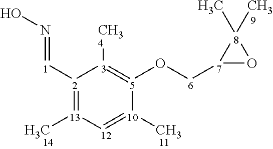

| | δ¹H (ppm) | δ¹³C (ppm) |
|---|---|---|
| 1 | 8.29 | 149.2 |
| 2 | / | 128.3 |
| 3 | / | 129.9 |
| 4 | 2.27 | 13.3 |
| 5 | / | 153.5 |
| 6 | 3.76 and 3.88 | 71.2 |
| 7 | 3.15 | 61.4 |
| 8 | / | 58 |
| 9 | 1.22 and 1.33 | 18.6 and 24.4 |
| 10 | / | 131.3 |
| 11 | 2.22 | 16.1 |
| 12 | 6.83 | 130.5 |
| 13 | / | 132.7 |
| 14 | 2.25 | 20.4 |

### Solvent CDCl₃

### Synthesis of 3-((3,3-dimethyloxiran-2-yl)methoxy)-2,4,6-trimethylbenzonitrile Oxide (D-2)

An aqueous solution of NaOCl in water (62.9 g CIA) (65 ml) is added dropwise over 15 minutes to a solution of 3-((3,3-dimethyloxiran-2-yl)methoxy)-2,4,6-trimethylbenzaldehyde oxime (9.90 g, 0.367 mol) in dichloromethane (350 ml) cooled to 1-3° C. The temperature of the reaction medium remains between 2-3° C. The reaction medium is then stirred for 2 hours at 2-3° C. The organic phase is separated out and washed with water (three times 50 ml). The solvent is evaporated off under reduced pressure (T_{bath} 21° C., 120 mbar). Petroleum ether (40/60) (15 ml) is added to this residue and the suspension is maintained at −18° C. for 2 hours. The precipitate is filtered off, washed on the filter with petroleum ether (three times 15 ml) and finally dried at atmospheric pressure at room temperature for 10-15 hours. A white solid (4.42 g, yield by mass of 45%) with a melting point of 84° C. is obtained. The molar purity is greater than 98% (¹H NMR).

Assignment table:

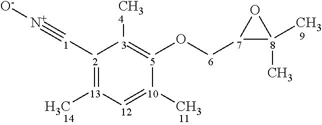

| | δ¹H (ppm) | δ¹³C (ppm) |
|---|---|---|
| 1 | / | / |
| 2 | / | 112.7 |
| 3 | / | 134.2 |
| 4 | 2.35 | 14.8 |
| 5 | / | 153.4 |
| 6 | 3.93/3.71 | 71.9 |
| 7 | 3.11 | 61.2 |
| 8 | / | 57.8 |
| 9 | 1.22 and 1.33 | 24.5/18.8 |
| 10 | / | 134.2 |
| 11 | 2.23 | 16.5 |
| 12 | 6.86 | 130.2 |
| 13 | / | 137.2 |
| 14 | 2.32 | 20 |

### Solvent CDCl₃

### Synthesis of 2,4,6-trimethyl-3-(3-(3-methyloxiran-2-yl)propoxy)benzonitrile Oxide (D-3)

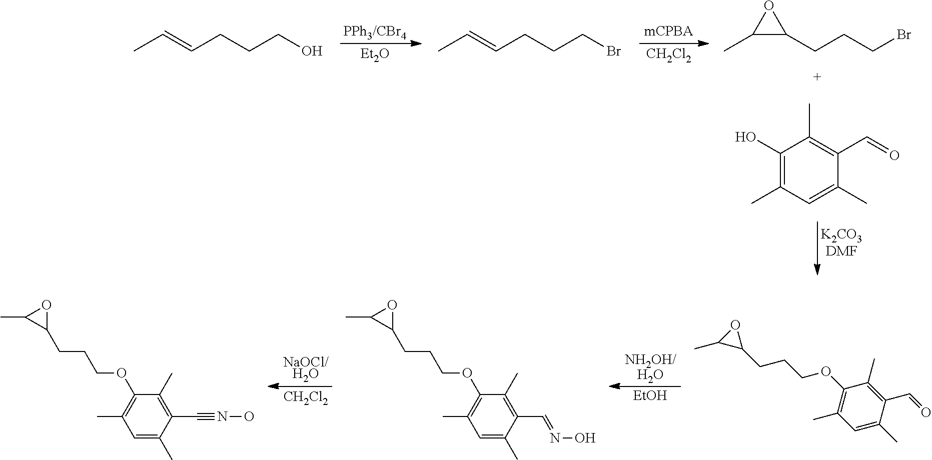

### Synthesis of 6-bromohex-2-ene

This compound may be obtained, for example, according to a procedure described in the article Nicolai, Stefano et al. Tetrahedron, 71(35), 5959-5964; 2015

### Synthesis of 2-(3-bromopropyl)-3-methyloxirane

This compound may be obtained, for example, according to a procedure described in the article Hu, Shanghai; Hager, Lowell P.; Tetrahedron Letters; vol. 40; nb. 9; (1999); pages 1641-1644.

### Synthesis of 2,4,6-trimethyl-3-(3-(3-methyloxiran-2-yl)propoxy)benzaldehyde

Potassium carbonate (6.01 g, 0.044 mol) is added to a mixture of 3-hydroxy-2,4,6-trimethylbenzaldehyde (10.00 g, 0.061 mol) and 2-(3-bromopropyl)-3-methyloxirane (10.39 g, 0.058 mol) in DMF (5 ml). The reaction medium is stirred at 80° C. (T_{bath}) for 1 hour and then at 100° C. (T_{bath}) for 3 hours. After returning to room temperature, the reaction mixture is diluted with a mixture of water (75 ml) and methylene chloride (50 ml). The product is extracted with methylene chloride (twice 10 ml). The combined organic phases are washed twice with NaOH solution (4 g in 50 ml of water) and with water (three times with 15 ml). The solvent is evaporated off under reduced pressure (T_{bath} 45° C., 8 mbar). An oil (14.25 g, yield by mass of 93%) is obtained. The molar purity is greater than 85% (¹H NMR). The product is used for the following step without any further purification.

Assignment table:

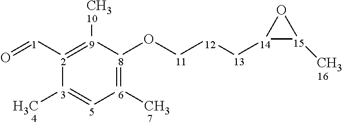

| | δ¹H (ppm) | δ¹³C (ppm) |
|---|---|---|
| 1 | 10.46 | 193.2 |
| 2 | / | 131.7 |
| 3 | / | 133.8 |
| 4 | 2.45 | 19.9 |
| 5 | 6.83 | 131.9 |
| 6 | / | 137 |
| 7 | 2.22 | 16.8 |
| 8 | / | 154.4 |
| 9 | / | 136.5 |
| 10 | 2.44 | 12.3 |
| 11 | 3.67 | 72.2 |
| 12 | 1.89 | 26.7 |
| 13 | 1.62-1.79 | 28.7 |
| 14 | 2.66 | 59.3 |
| 15 | 2.75 | 54.5 |
| 16 | 1.25 | 17.6 |

### Solvent CDCl₃

### Synthesis of 2,4,6-trimethyl-3-(3-(3-methyloxiran-2-yl)propoxy)benzaldehyde Oxime

A solution of hydroxylamine (5.13 g, 0.078 mol, 50% in water, Aldrich) in ethanol (10 ml) is added to a solution of 2,4,6-trimethyl-3-(3-(3-methyloxiran-2-yl)propoxy)benzaldehyde (14.00 g, 0.056 mol) in ethanol (40 ml) at 45° C. The reaction medium is stirred at 50° C. (T_{bath}) for 1.5 hours. After evaporating off the solvent (T_{bath} 40° C., 45 mbar), methylene chloride (50 ml) is added and the solution is washed with water (three times 15 ml). After evaporating off the solvent (T_{bath} 40° C., 70 mbar), methylene chloride is then added. The suspension is stirred at room temperature for 10 minutes and cooled to −18° C. for 10-15 minutes. The precipitate is filtered off, washed on the filter three times with a mixture of methylene chloride (1 ml) and petroleum ether (4 ml) and finally dried at atmospheric pressure at room temperature. A white solid (10.02 g, yield by mass of 65%) with a melting point of 78° C. is obtained. The molar purity is greater than 90% (¹H NMR).

Assignment table:

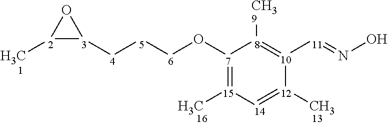

| | δ¹H (ppm) | δ¹³C (ppm) |
|---|---|---|
| 1 | 1.26 | 17.6 |
| 2 | 2.76 | 54.7 |
| 3 | 2.68 | 59.5 |
| 4 | 1.65/1.79 | 28.8 |
| 5 | 1.88 | 26.8 |
| 6 | 3.68 | 72.0 |
| 7 | / | 154.1 |
| 8 | / | 130.4 |
| 9 | 2.24 | 13.6 |
| 10 | / | 128.4 |
| 11 | 8.30 | 149.9 |
| 12 | / | 132.7 |
| 13 | 2.25 | 20.5 |
| 14 | 6.82 | 130.8 |
| 15 | / | 131.8 |
| 16 | 2.19 | 16.3 |

### Solvent CDCl₃

### Synthesis of 2,4,6-trimethyl-3-(3-(3-methyloxiran-2-yl)propoxy)benzonitrile Oxide (D-3)

An aqueous solution of NaOCl in water (4% of active chlorine, Aldrich) (17 ml) is added dropwise over 5 minutes to a solution of 2,4,6-trimethyl-3-(3-(3-methyloxiran-2-yl)propoxy)benzaldehyde oxime (3.35 g, 0.012 mol) in dichloromethane (50 ml) cooled to 0° C. (T_{bath}). The temperature of the reaction medium remains between 3 and 5° C.. The reaction medium is then stirred for 1 hour at a temperature of 3-5° C. The aqueous phase is separated out and then extracted with dichloromethane (5 ml). The combined organic phases are washed with water (twice 5 ml). The solvent is evaporated off under reduced pressure (T_{bath} 21° C., 16 mbar). Petroleum ether (40/60) (7 ml) is added to this residue and the suspension is stirred at room temperature for 10 minutes. The precipitate is filtered off, washed on the filter with petroleum ether (twice 5 ml) and finally dried at atmospheric pressure at room temperature. A pale yellow solid (2.49 g, yield by mass of 75%) with a melting point of 56° C. is obtained. The molar purity is greater than 94% (¹H NMR).

Assignment table:

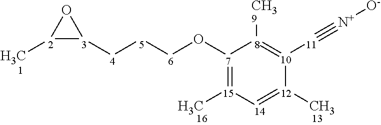

| | δ¹H (ppm) | δ¹³C (ppm) |
|---|---|---|
| 1 | 1.26 | 17.6 |
| 2 | 2.75 | 54.5 |
| 3 | 2.66 | 59.3 |
| 4 | 1.60/1.80 | 28.7 |
| 5 | 1.88 | 26.8 |
| 6 | 3.68 | 72.2 |
| 7 | / | 153.9 |
| 8 | / | 137.1 or 134.6 |
| 9 | 2.31 | 14.9 |
| 10 | / | 112.8 |
| 11 | / | / |
| 12 | / | 137.1 or 134.6 |
| 13 | 2.31 | 20.3 |
| 14 | 6.84 | 130.3 |
| 15 | / | 134.6 |
| 16 | 2.19 | 16.5 |

### Solvent CDCl₃

### Synthesis of 2,4,6-trimethyl-3-((3-phenyloxiran-2-yl)methoxy]benzonitrile Oxide (D-4)

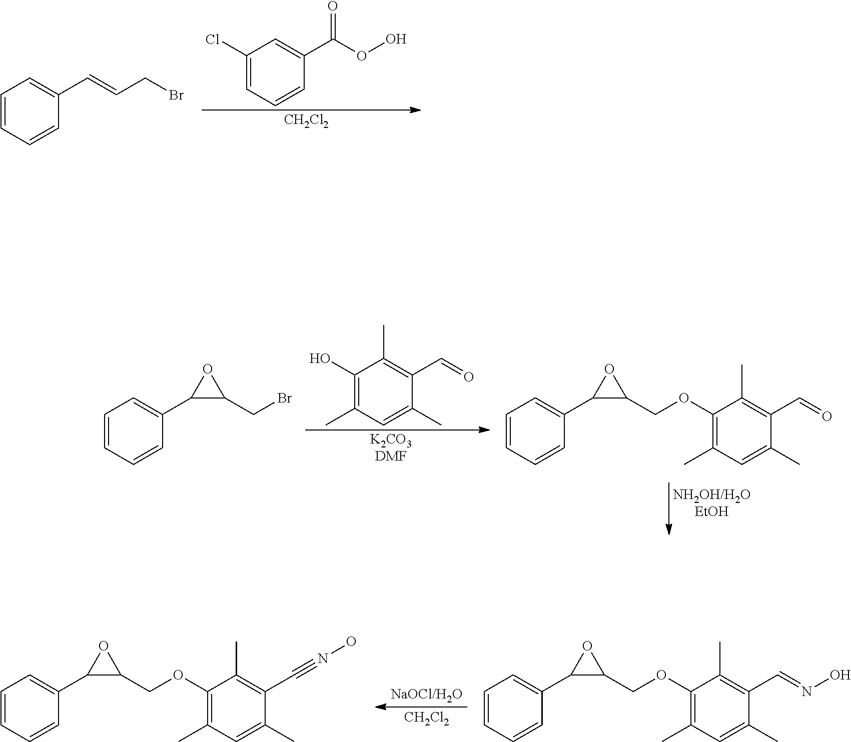

### Synthesis of 2-(bromomethyl)-3-phenyloxirane

This compound may be obtained according to a procedure described in the article Dickinson, Julia M. et al., Chemical Society, Perkin Transactions 1: Organic and Bio-Organic Chemistry (1972-1999), (4), 1179-84; 1990.

### Synthesis of 2,4,6-trimethyl-3-(3-(3-phenyloxiran-2-yl)methoxy)benzaldehyde

Potassium carbonate (8.51 g, 0.062 mol) is added to a mixture of 3-hydroxy-2,4,6-trimethylbenzaldehyde (13.50 g, 0.082 mol) and 2-(bromomethyl)-3-phenyloxirane (17.50 g, 0.082 mol) in DMF (8 ml). The reaction medium is stirred at 60° C. (T_{bath}) for 5-6 hours. After returning to 40-50° C., the reaction mixture is diluted with a mixture of water (200 ml) and ethyl acetate (70-80 ml). The target product is extracted with ethyl acetate (twice 25 ml). The combined organic phases are washed with NaOH solution (8 g in 70 ml of water) and with water (four times 25 ml). The solvent is evaporated off under reduced pressure (T_{bath} 34° C., 16 mbar). Petroleum ether (40/60) (50 ml) is added and the precipitate is filtered off, washed on the filter with a mixture of petroleum ether (15 ml) and ethyl acetate (1 ml) and finally dried at atmospheric pressure at room temperature.

A beige-coloured solid (13.28 g, yield by mass of 55%) with a melting point of 53° C. is obtained. The molar purity is greater than 90% CH NMR).

Assignment table:

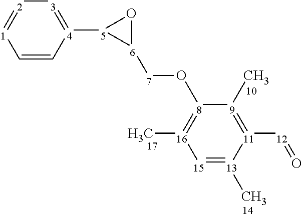

| | | |
|---|---|---|
| 1/2 | 7.18 to 7.34 | 128.2/128.3 |
| 3 | | 125.5 |
| 4 | / | 136.2 |
| 5 | 3.81 | 55.9 |
| 6 | 3.35 | 60.2 |
| 7 | 3.84 and 4.04 | 72.5 |
| 8 | / | 153.8 |
| 9/13/16 | / | 132/133.7/136.7 |
| 10 | 2.5 | 12.2 |
| 11 | / | 131.5 |
| 12 | 10.48 | 193 |
| 14 | 2.48 | 19.8 |
| 15 | 6.87 | 131.8 |
| 17 | 2.28 | 16.6 |

### Solvent CDCl₃

### Synthesis of 2,4,6-trimethyl-3-((3-phenyloxiran-2-yl)methoxy)benzaldehyde Oxime

A solution of hydroxylamine (1.43 g, 0.022 mol, 50% in water, Aldrich) in ethanol (5 ml) is added to a solution of 2,4,6-trimethyl-3-((3-phenyloxiran-2-yl)methoxy)benzaldehyde (4.60 g, 0.016 mol) in ethanol (20 ml) at 45° C. The reaction medium is stirred at 50° C. (T_{bath}) for 1.5 hours. After returning to room temperature, water (3 ml) is added to the suspension and the suspension is maintained at −18° C. for 2 hours. The precipitate is filtered off, washed on the filter with ethanol and water (3 ml/2 ml and 1 ml/4 ml) and finally dried at atmospheric pressure at room temperature. A white solid (3.62 g, yield by mass of 75%) with a melting point of 125° C. is obtained. The molar purity is greater than 97% CH NMR).

Assignment table:

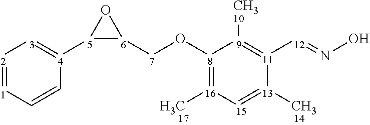

| | δ¹H (ppm) | δ¹³C (ppm) |
|---|---|---|
| 1/2 | 7.21 to 7.35 | 128/128.2 |
| 3 | | 125.4 |
| 4 | / | 136.2 |
| 5 | 3.81 | 56 |
| 6 | 3.35 | 60.3 |
| 7 | 3.85 and 4.02 | 72.2 |
| 8 | / | 153.4 |
| 9 | / | 130.2 |
| 10 | 2.29 | 13.1 |
| 11 | / | 128.2 |
| 12 | 8.31 | 149.6 |
| 13 | / | 132.9 |
| 14 | 2.27 | 20.3 |
| 15 | 6.85 | 130.7 |
| 16 | / | 131 |
| 17 | 2.24 | 16 |

### Solvent CDCl₃

### Synthesis of 2,4,6-trimethyl-3-((3-phenyloxiran-2-yl)methoxy]benzonitrile Oxide (D-4)

An aqueous solution of NaOCl in water (74.4 g Cl/I) (48 ml) is added dropwise over 15 minutes to a solution of 2,4,6-trimethyl-3-((3-phenyloxiran-2-yl)methoxy)benzaldehyde oxime (10.20 g, 0.033 mol) in dichloromethane (150 ml) cooled to 4° C. The temperature of the reaction medium remains between 3 and 5° C. The reaction medium is then stirred for 2.5 hours at a temperature of 3-5° C. The aqueous phase is separated out and extracted with dichloromethane (15 ml). The combined organic solutions are washed with water (three times 20 ml). The solvent is evaporated off under reduced pressure (T_{bath} 23° C., 22 mbar).

Petroleum ether (40/60) (60 ml) is added and the suspension is stirred at room temperature for 10-15 minutes. The precipitate is filtered off, washed on the filter with petroleum ether (twice with 20 ml) and finally dried at atmospheric pressure at room temperature. A white solid (8.35 g, yield by mass of 82%) with a melting point of 64° C. is obtained. The molar purity is greater than 98% CH NMR).

Assignment table:

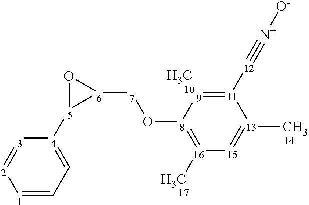

| | δ¹H (ppm) | δ¹³C (ppm) |
|---|---|---|
| 1/2 | 7.21 to 7.35 | 128.2/128.4 |
| 3 | | 125.4 |
| 4 | / | 136.1 |
| 5 | 3.79 | 55.8 |
| 6 | 3.33 | 60.1 |
| 7 | 3.82 and 4.05 | 72.5 |
| 8 | / | 153.3 |
| 9/13/16 | / | 130.3/134.4/137.3 |
| 10 | 2.36 | 14.6 |
| 11 | / | 112.8 |
| 12 | / | / |
| 14 | 2.33 | 20.1 |
| 15 | 6.87 | 130.2 |
| 17 | 2.25 | 16.4 |

### Solvent CDCl₃

### II.4-Preparation of the Rubber Compositions:

Five rubber compositions T, C-1, C-2, C-3 and C-4, respectively, the formulation of which (in phr) is given in Table I, are prepared.

The elastomer of composition T is an unmodified elastomer, in this instance the starting elastomer E1 used for preparing the modified elastomers of compositions 1 to 4. Composition T is a control composition, since it contains the starting (unmodified) diene elastomer.

The elastomer of composition C-n (n ranging from 1 to 4) is the elastomer E1 modified in accordance with section 11-2 with the 1,3-dipolar compound D-n.

Composition C-1 is a comparative composition, since the modified elastomer of composition C-1 is not in accordance with the invention, the epoxide group not corresponding to formula (I).

Compositions C-2 to C-4 are in accordance with the invention, since the modified elastomers of the rubber compositions are in accordance, the epoxide group not corresponding to formula (I).

The rubber compositions are prepared according to the following procedure:

The elastomer is introduced into an internal mixer, the initial vessel temperature of which is about 80° C., and is kneaded for about 1 minute. The reinforcing filler, the silane and then, after 1-2 minutes of kneading, the various other ingredients, with the exception of the vulcanization system, are then introduced. Thermomechanical working is then performed (non-productive phase) in one step (total duration of the kneading equal to about 5 minutes), until a maximum “dropping” temperature of 145° C. is reached. The mixture thus obtained is recovered and cooled and the vulcanization system (sulfur) is then added on an external mixer (homofinisher) at 25° C., the whole being mixed (productive phase) for about 5 to 6 minutes. The mixture is then calendered in the form of plates (thickness of 2 to 3 mm) for measurement of the tensile properties and of the dynamic properties. The mixture is then vulcanized, and its rheometric properties and cured properties are measured.

The results are given in Table II. The results are indicated in base 100 relative to the control composition (T): the value indicated for a composition is the ratio between the value measured on the composition and the value measured on the control composition.

The vulcanized compositions C-2 to C-4 have an elongation at break and a breaking stress that are improved relative to the composition C-1. These results are obtained without being at the expense of the hysteresis properties, since the ΔG* and Tan(δ) max values remain very much lower than that of the control composition (T). The ΔC values, which are lower than that of composition T, corroborate an improvement in the interaction between the elastomer and the reinforcing filler.

It is also observed that the Cmin values of compositions C-2 to C-4 are lower than that of composition C-1, which indicates a decrease in the viscosity in the uncured state (before vulcanization) of the compositions and suggests the likelihood of implementation of compositions C-2 to C-4 that is at least as easy as that of composition T. This result is all the more surprising since an improvement in the interaction between the elastomer and the reinforcing filler has moreover been found.

In summary, the polymers in accordance with the invention give the rubber compositions an improved compromise between the rupture properties, the hysteresis properties and the implementation properties when compared with the polymers not in accordance with the invention. They thus make it possible to substantially improve the properties of the rubber compositions.

TABLE I

| Composition | T | C-1 | C-2 | C-3 | C-4 |
|---|---|---|---|---|---|
| E1 | 100 | | | | |
| E1 modified with D-1 | | 100 | | | |
| E1 modified with D-2 | | | 100 | | |
| E1 modified with D-3 | | | | 100 | |
| E1 modified with D-4 | | | | | 100 |
| Silica (1) | 60 | 60 | 60 | 60 | 60 |
| Silane (2) | 4.8 | 4.8 | 4.8 | 4.8 | 4.8 |
| Antioxidant (3) | 3 | 3 | 3 | 3 | 3 |
| Paraffin (4) | 1 | 1 | 1 | 1 | 1 |
| ZnO (5) | 2.7 | 2.7 | 2.7 | 2.7 | 2.7 |
| Stearic acid | 2.5 | 2.5 | 2.5 | 2.5 | 2.5 |
| CBS (6) | 1.8 | 1.8 | 1.8 | 1.8 | 1.8 |
| Sulfur | 1.5 | 1.5 | 1.5 | 1.5 | 1.5 |

(1) 160 MP silica sold by Solvay
(2) TESPT sold by Evonik under the reference Sl69
(3) N-(1,3-dinnethylbutyl)-N′-phenyl-p-phenylenediamine from the company Flexsys
(4) Paraffin 6266 processing aid
(5) Zinc oxide
(6) N-cyclohexyl-2-benzothiazolesulfenamide (Santocure CBS from the company Flexsys)

TABLE II

| Composition | T | C-1 | C-2 | C-3 | C-4 |
|---|---|---|---|---|---|
| Elongation at break | 100 | 58 | 84 | 68 | 74 |
| Breaking stress | 100 | 90 | 111 | 97 | 97 |
| ΔG* | 100 | 71 | 79 | 88 | 88 |
| Tan (δ) max | 100 | 73 | 73 | 81 | 73 |
| C min | 100 | 110 | 74 | 74 | 84 |
| ΔC | 100 | 68 | 76 | 94 | 66 |

1. A diene polymer including at least one epoxide side group of formula (I) 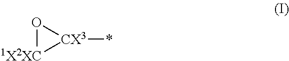
in which:
* represents an attachment to the main polymer chain,
X¹ and X², which may be identical or different, represent a hydrogen atom or a monovalent substituent,
X³ represents a hydrogen atom, and
at least one from among X¹ and X² is other than a hydrogen atom.

2. The diene polymer according to claim 1, in which the polymer includes several epoxide side groups of formula (I) 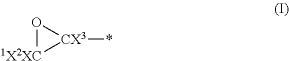
in which:
* represents an attachment to the main polymer chain,
X¹ and X², which may be identical or different, represent a hydrogen atom or a monovalent substituent,
X³ represents a hydrogen atom, and
at least one from among X¹ and X² is other than a hydrogen atom.

3. The diene polymer according to claim 1, in which X¹ represents a substituent group and X² represents a hydrogen atom.

4. The diene polymer according to claim 1, in which X¹ and X² each represent a substituent group.

5. The diene polymer according to claim 1, in which the substituent group is a hydrocarbon-based group.

6. The diene polymer according to claim 1, in which the substituent group is an alkyl or an aryl.

7. The diene polymer according to claim 1, in which the substituent group is an alkyl containing 1 to 6 carbon atoms or is an aryl containing 6 to 12 carbon atoms.

8. The diene polymer according to claim 1, in which the epoxide group is outside of the ends of the main polymer chain.

9. The diene polymer according to claim 1, which polymer is chosen from the group consisting of polybutadienes, polyisoprenes, 1,3-butadiene copolymers, isoprene copolymers and a mixture thereof.

10. The diene polymer according to claim 1, in which the polymer is an elastomer.

11. A rubber composition based which comprises a reinforcing filler, a crosslinking system and the diene polymer defined in claim 1.

12. The rubber composition according to claim 11, in which the reinforcing filler comprises a reinforcing inorganic filler.

13. A tire which comprises the rubber composition defined in claim 11.

14. The diene polymer according to claim 1, in which the substituent group is methyl or phenyl.

15. The rubber composition according to claim 12, in which the reinforcing inorganic filler comprises silica.
